(19) United States
(12) Patent Application Publication
(10) Pub. No.: US 2026/0078909 A1
(43) Pub. Date: Mar. 19, 2026

(54) VERTICAL FIRE DISPLAY SYSTEMS AND METHODS

(71) Applicant: HNI Technologies Inc., Muscatine, IA (US)

(72) Inventors: Tommie Kelley, Lakeville, MN (US); Moffat Omuya, Lakeville, MN (US); Destin Peters, Lakeville, MN (US); Hunter Miller, Lakeville, MN (US); Jacob Clifton, Lakeville, MN (US); Timothy Johnson, Lakeville, MN (US); Joseph Kueffler, Lakeville, MN (US); Corey Radloff, Lakeville, MN (US); Julie Milum, Lakeville, MN (US); Erika Saffer, Lakeville, MN (US); Gary Butler, Lakeville, MN (US); Wayne Kuechenmeister, Lakeville, MN (US); Richard Berg, Lakeville, MN (US)

(21) Appl. No.: 19/329,227

(22) Filed: Sep. 15, 2025

Related U.S. Application Data
(60) Provisional application No. 63/694,662, filed on Sep. 13, 2024.

(51) Int. Cl. F24C 7/00; F21S 10/04

(52) U.S. Cl. CPC F24C 7/004; F21S 10/04

(57) ABSTRACT

Various systems and methods of electric fireplaces are disclosed herein. An electric fireplace includes a display defined by a plurality of individual LED panels arranged in an array such that an image extends continuously and uninterrupted across at least a portion of the plurality of panels. Optionally, the electric fireplace includes a controller operatively coupled to the display, the controller operable to change one or more properties of the display in response to a user-input.

### CROSS-REFERENCE TO RELATED APPLICATION

This application claims the benefit of Provisional Application No. 63/694,662, filed Sep. 13, 2024, which is incorporated herein by reference in its entirety for all purposes.

### BACKGROUND

Rotisserie fireplaces include a rotisserie system having a rotating rod driven by an electric motor. Inclusion of the rotisserie system can increase the depth of the fireplace, in some examples adding at least 6 inches of depth, which may require an in-wall installation within a wall cavity carved into the wall. Creation of the wall cavity can be messy, expensive, and impractical for consumers with limited wall space, such as an apartment or a mobile home. Additionally, inclusion of mechanical rotisserie components can create unwanted noise during operation of the fireplace, leading to service calls and warranty repairs.

New electric fireplaces with digital displays have aimed to overcome these challenges, but can still be difficult for consumers to install or mount to a wall, and in the configuration they prefer.

### SUMMARY

These inventive concepts improve the manner by which a fire display system may be installed or mounted to a wall by allowing a user to mount the display in either a vertical or horizontal orientation using the same components, as well as improving the visual features of the fire display system. As disclosed herein, electric fireplaces may be mounted in a horizontal or vertical orientation based on user preference. In some embodiments, the electric fireplaces are defined by a plurality of panels arranged in an array. The panels may include LED panels that do not have bezels, or other dead space, extending about edges of the panels. This allows an image (such as a visual representation of a fire) to extend continuously and uninterrupted across at least a portion of the plurality of panels without dead space interrupting the image. The array may be modular such that the plurality of panels can be arranged to form customized shapes and customized aspect ratios. The electric fireplaces discussed herein do not require use of a gas line, a gas tank, or other fuel sources. Instead, a plurality of LED lights, arranged as an LED panel, or screens may simulate the appearance of flames.

The following summary is not meant to be an exclusive list of the inventive concepts addressed by this patent specification.

In one embodiment (Embodiment 1), an electric fireplace, fire display, or fire feature comprises a housing, including a screen configured to display a video of a flame where the screen is configured to be mounted in a screen orientation, an orientation sensor operatively coupled to the screen and configured to sense a direction of the screen orientation and selectively display the video in a video direction corresponding to the direction of the screen orientation, and at least one rear facing lighting element coupled to the housing opposite the screen, the at least one rear facing lighting element configured to display dynamic lighting.

In another embodiment (Embodiment 2), further to Embodiment 1, the electric fireplace, fire display, or fire feature further includes a controller operatively coupled to the at least one rear facing lighting element.

In another embodiment (Embodiment 3), further to Embodiment 1 or 2, the controller includes one of a mobile app, a remote, and a smart home system.

In another embodiment (Embodiment 4), further to Embodiment 3, the electric fireplace, fire display, or fire feature further includes a heating system including at least one heater coupled to the housing.

In another embodiment (Embodiment 5), further to Embodiment 4, the heating system is operatively coupled to the controller.

In another embodiment (Embodiment 6), further to Embodiment 2 or 3, the electric fireplace, fire display, or fire feature further includes a speaker system including at least one speaker coupled to the housing.

In another embodiment (Embodiment 7), further to Embodiment 6, the speaker system is operatively coupled to the controller.

In another embodiment (Embodiment 8), further to any one of Embodiments 1-7, the screen includes a digital display including at least one of a television, a computer monitor, a liquid crystal display, an organic light-emitting diode display, and an array or strip of light emitting diodes.

In another embodiment (Embodiment 9), further to any one of Embodiments 1-8, the at least one rear facing lighting element includes a plurality of LEDs.

In another embodiment (Embodiment 10), further to any one of Embodiments 1-9, the electric fireplace, fire display, or fire feature is configured to mount onto a wall, and at least one rear facing lighting element displays dynamic lighting onto the wall.

In another embodiment (Embodiment 11), further to any one of Embodiments 1-10, the at least one rear facing lighting element includes a cover, and the cover includes at least one of a transparent, semi-transparent, opaque, or semi-opaque material.

In another embodiment (Embodiment 12), further to any one of Embodiments 1-11, the screen orientation is generally vertical.

In another embodiment (Embodiment 13), further to any one of Embodiments 12, the screen orientation is generally horizontal.

In one embodiment (Embodiment 14), an electric fireplace, fire display, or fire feature is configured to mount to a wall. The electric fireplace, fire display, or fire feature comprises a housing having a front facing side and a rear facing side opposite the front-facing side, the front facing side including a screen configured to display a video of a flame, the housing including a frame defining a perimeter, a speaker assembly coupled to the perimeter, a heating assembly coupled to the perimeter, at least one rear facing lighting element coupled to the rear facing side of the housing configured to display dynamic lighting onto the wall, and a controller operatively coupled to the speaker assembly, the heating assembly, and the at least one rear facing lighting element. An input signal from any of the speaker assembly, the heating assembly, or the at least one rear facing lighting elements changes a feature of the video of the flame.

In another embodiment (Embodiment 15), further to Embodiment 14, when the input signal causes an increase in heat production of the heat assembly, and the feature of the video is an increase in a height of the flame.

In another embodiment (Embodiment 16), further to Embodiment 14, when the input signal causes a decrease in heat production of the heat assembly, and the feature of the video is a decrease in a height of the flame.

In another embodiment (Embodiment 17), further to Embodiment 14, when the input signal causes an increase in volume from the speaker assembly, and the feature of the video is an increase in a height of the flame.

In another embodiment (Embodiment 18), further to Embodiment 14, when the input signal causes a decrease in volume from the speaker assembly, and the feature of the video is a decrease in a height of the flame.

In another embodiment (Embodiment 19), further to Embodiment 14, when the input signal causes an increase in brightness from the at least one rear facing lighting element, and the feature of the video is an increase in a height of the flame.

In another embodiment (Embodiment 20), further to Embodiment 14, when the input signal causes a decrease in brightness from the at least one rear facing lighting element, and the feature of the video is a decrease in a height of the flame.

In one embodiment (Embodiment 21), an electric fireplace comprises a display defined by a plurality of individual LED panels arranged in an array such that an image extends continuously and uninterrupted across at least a portion of the plurality of panels and a controller operatively coupled to the display, the controller operable to change one or more properties of the display in response to a user-input.

In another embodiment (Embodiment 22), further to Embodiment 21, the image extends to an edge of each panel of the plurality of panels.

In another embodiment (Embodiment 23), further to Embodiment 21, the array is modular and can be configured into a customized shape.

In one embodiment (Embodiment 24), an electric fireplace comprises a display defined by a plurality of LED panels arranged in a modular array, wherein the modular array is customizable by at least one of a shape of the array or an aspect ratio of the array and a controller operatively coupled to the display, the controller operable to change one or more properties of the display in response to a user-input.

In another embodiment (Embodiment 25), further to Embodiment 24, the shape includes one of a rectangle, a square, an L-shape, or a U-shape.

In another embodiment (Embodiment 26), further to Embodiment 24, at least one panel of the plurality of panels includes a non-linear edge.

In another embodiment (Embodiment 27), further to Embodiment 26, the shape includes one of a circle, an oval, or a curve.

In another embodiment (Embodiment 28), further to Embodiment 24, each panel of the plurality of panels is individually controllable by the controller.

In another embodiment (Embodiment 29), further to Embodiment 24, the electric fireplace further includes one or more accessories operatively coupled to the controller, wherein the one or more accessories include a speaker system, a heating system, and a backlight.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure. For reference, the terms “top” or “upper”, “bottom” or “lower”, and “side” as used with regard to the orientation of the views are meant to denote orientations of the device at different rotational angles around the central longitudinal axis of the device. For example, where the “top” view corresponds to an angular rotation of 0 degrees, the “bottom” view would be offset from the “top” view at a rotational angle of 180 degrees, and the “side” view by a rotational angle of 90 degrees.

FIG. 1 illustrates an electric fireplace system mounted on a wall, in accordance with an embodiment;

FIG. 2 illustrates an electric fireplace of the electric fireplace system of FIG. 1 in a vertical orientation, in accordance with an embodiment;

FIG. 3 illustrates another embodiment of the electric fireplace of FIG. 1 having more than one display, in accordance with an embodiment;

FIG. 4 illustrates the electric fireplace of FIG. 1 in a horizontal orientation, in accordance with an embodiment;

FIG. 5 illustrates a diagram of an orientation sensor, in accordance with an embodiment;

FIG. 6 illustrates a housing of the electric fireplace of FIG. 2 and accessories of the housing, in accordance with an embodiment;

FIG. 7 illustrates a diagram of a controller operatively coupled to the electric fireplace, in accordance with an embodiment;

FIG. 8A illustrates rear lighting elements in association with the electric fireplace, in accordance with an embodiment;

FIG. 8B illustrates a cover for the rear lighting elements of FIG. 8A, in association with an embodiment;

FIG. 9A illustrates a prior art embodiment of an electric fireplace defined by panels having dead space between panels of the electric fireplace, in accordance with an embodiment;

FIG. 9B illustrates the electric fireplace of FIG. 9A without the visual representation of the fire, in accordance with an embodiment;

FIG. 10A illustrates an electric fireplace defined by eight panels without dead space therebetween, in accordance with an embodiment;

FIG. 10B illustrates the electric fireplace of FIG. 10A without the visual representation of the fire, in accordance with an embodiment;

FIG. 11 illustrates an electric fireplace defined by four panels, in accordance with an embodiment;

FIG. 12 illustrates an electric fireplace defined by nine panels, in accordance with an embodiment;

FIG. 13 illustrates an electric fireplace defined by panels having non-linear edges, in accordance with an embodiment;

FIG. 14 illustrates an electric fireplace with a background image, in accordance with an embodiment;

FIG. 15A illustrates an electric fireplace with more than one visual representation of a fire, in accordance with an embodiment;

FIG. 15B illustrates an electric fireplace with a substantially continuous visual representation of a fire, in accordance with an embodiment;

FIG. 16A illustrates a light with more than one visual representation of a fire, in accordance with an embodiment;

FIG. 16B illustrates a light with a substantially continuous visual representation of a fire, in accordance with an embodiment;

FIG. 17 shows an example of a panel of an electric fireplace, in accordance with an embodiment; and FIG. 18 illustrates an electric fireplace with a cover material displaying a reflected representation of a fire, in accordance with an embodiment.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

### Description of Various Inventive Embodiments With Reference to the Figures

Persons skilled in the art will readily appreciate that various aspects of the present disclosure can be realized by any number of methods and apparatuses configured to perform the intended functions. It should also be noted that the accompanying figures referred to herein are not necessarily drawn to scale, but may be exaggerated to illustrate various aspects of the present disclosure, and in that regard, the drawing figures should not be construed as limiting. The inventions described herein include, but are not limited, to the following description.

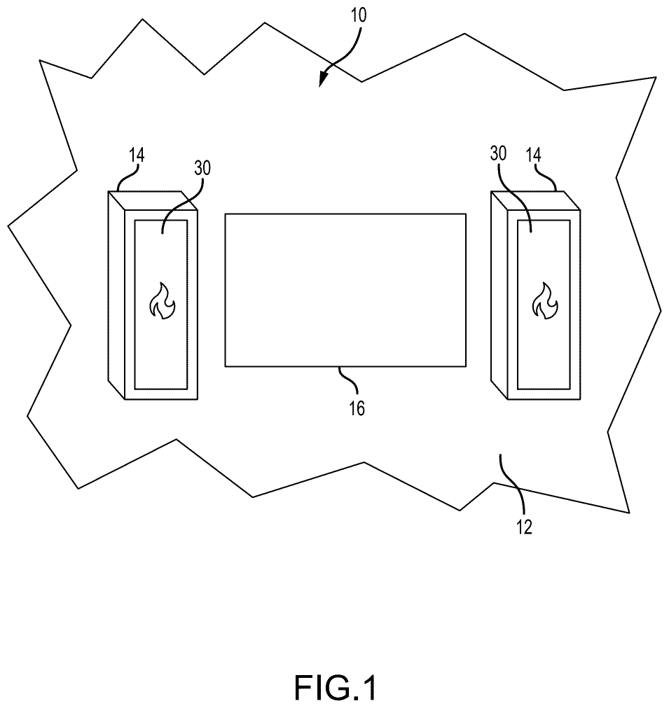

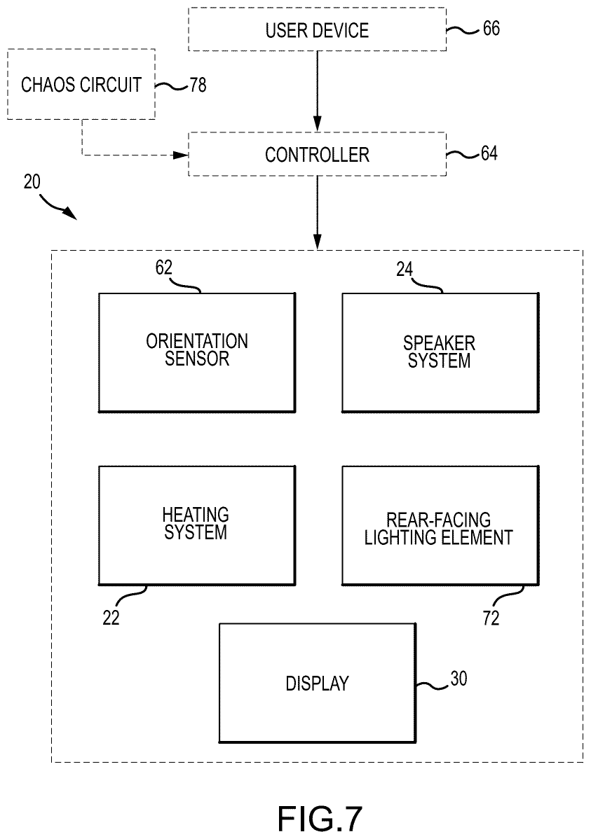

FIG. 1 shows a first embodiment of an electric fireplace system 10 mounted on a wall 12. The electric fireplace system 10 may include at least one electric fireplace 14. Optionally, more than one electric fireplace 14 can be mounted along the wall 12, such as two electric fireplaces 14 that are substantially similar to each other. In other examples, the electric fireplace system 10 includes a single electric fireplace 14. As shown in FIG. 1, the electric fireplace 14 may be mounted on the wall 12 adjacent to a television 16. In some embodiments, the two electric fireplaces 14 are operatively coupled via a controller 64 (FIG. 7) or via a smart home system.

The electric fireplace 14 is, in some examples, a fire feature or a fire display configured to simulate a burning fireplace. In some examples, the fire feature or the fire display is a digitally displayed fire (or a visual representation of a fire 30), which may optionally include one or more accessories 20 including but not limited to, a heating system 22 (FIG. 7) and a speaker system 24 (FIG. 7) that are configured to simulate aspects of a fireplace.

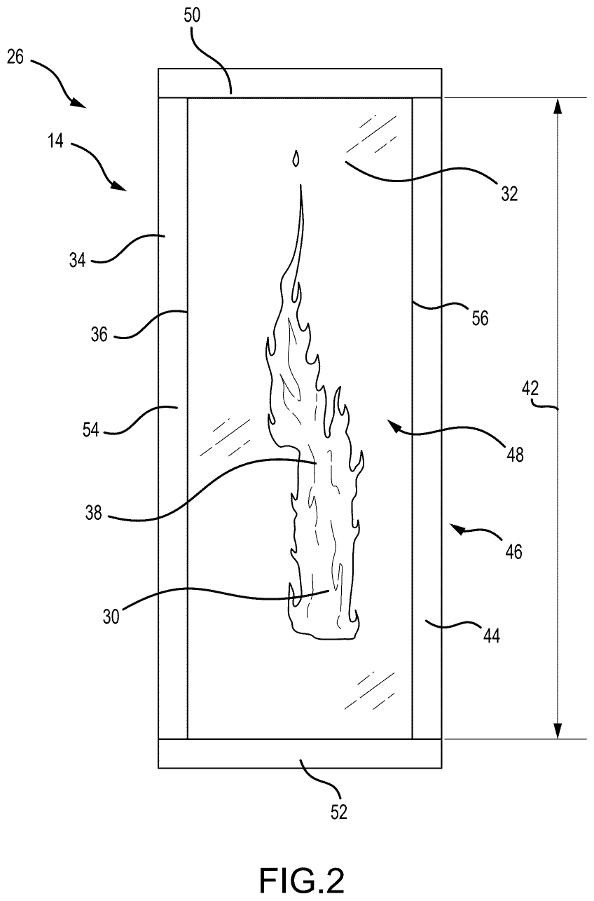

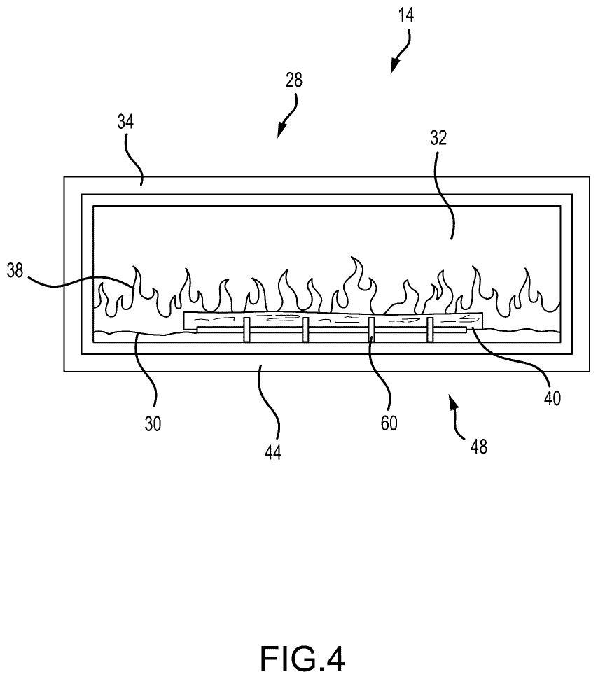

As shown in FIG. 2, the electric fireplace 14 may be mounted in a vertical orientation 26 on the wall 12. In some examples, the vertical orientation 26 reduces a footprint of the electric fireplace 14 and reduces an amount of wall space covered by the electric fireplace 14 as compared to a horizontal orientation 28 (e.g., FIG. 4). For example, as shown in FIG. 1, the vertical orientation may allow an installer to mount the at least one electric fireplace 14 next to the television 16 instead of below or above the television 16, which increases versatility of the electric fireplace system 10. This also allows a user with limited wall space to use the electric fireplace system 10, such as within an apartment or mobile home. In other examples, the vertical orientation may allow an installer to mount the electric fireplace 14 between two wall studs of the wall 12, which minimizes installation time and mess as compared to an in-wall, or wall cavity installation method.

In some embodiments, the electric fireplace 14 displays a visual representation of a fire 30 digitally on a screen 32. As such, mechanical components such as a rotisserie system and associated components may be eliminated from the electric fireplace 14. Elimination of the rotisserie system may contribute to a reduction in extraneous noise and a reduction in failure rates of the electric fireplace 14, and associated repair and replacement hassles, as compared to rotisserie fireplaces. Additionally, elimination of the rotisserie system may reduce the weight, cost, and depth of the electric fireplace 14 as compared to rotisserie fireplaces. In some examples, a depth of the electric fireplace 14 may generally correspond to that of a digital screen and the depth may be approximately 2 inches, approximately 1 inch, or approximately 0.5 inches.

FIG. 2 shows a first embodiment of the electric fireplace 14 of the electric fireplace system 10 of FIG. 1. The electric fireplace 14 includes a housing 34 having a front face 36 and a rear face (not shown) opposite the front face 36. The front face 36 may include at least one screen 32 configured to provide the visual representation of a fire 30. The screen 32 may include a digital display including, but not limited to, a television, computer monitor, a liquid crystal display (LCD), an organic light-emitting diode (OLED) display, or an array of light emitting diodes (LEDs). The visual representation of the fire 30 may include images or videos displaying the fire, including a flame 38 and optionally a fuel source 40 such as wood logs (e.g., FIG. 4) or coal, or other elements of a traditional gas fireplace such as embers, crystals, and artificial logs. As shown in FIG. 2, the electric fireplace 14 may include one screen 32. The visual representation of the fire 30 may extend substantially over a length 42 of the screen 32, or may extend over only a portion of the length 42 of the screen 32 such as three-quarters of the length 42 of the screen 32, half of the length 42 of the screen 32, or less than half of the length 42 of the screen 32.

The housing 34 includes a frame 44 defining a frame perimeter 46. The frame 44 surrounds a perimeter 48 of the screen 32. The frame perimeter 46 includes a top side 50, a bottom side 52 opposite the top side 50, a first side 54, and a second side 56 opposite the first side 54. The top side 50 and the bottom side 52 may be shorter than the first and second sides 54, 56. A longitudinal axis is defined between the top and bottom sides 50, 52. The electric fireplace 14 may optionally include an enclosure on the rear facing side positioned generally opposite to the screen 32 (e.g., against a wall, not shown) to house electronic components, such as a power cord.

As shown, the frame 44 may be generally rectangular, though other shapes such as squares are contemplated. In other embodiments, the frame 44 may include other unique or custom shapes including, but not limited to a U-shape or spiral shape.

As shown in FIG. 2, the electric fireplace 14 may be mounted in a vertical orientation 26 such that the frame 44 and the screen 32 are both vertical and extend along the longitudinal axis 58. When the screen 32 is in the vertical orientation 26, the visual representation of the fire 30 also extends vertically along the longitudinal axis 58. The vertical orientation 26 of the electric fireplace 14 allows for flexibility in positioning along the wall 12, as discussed with respect to FIG. 1.

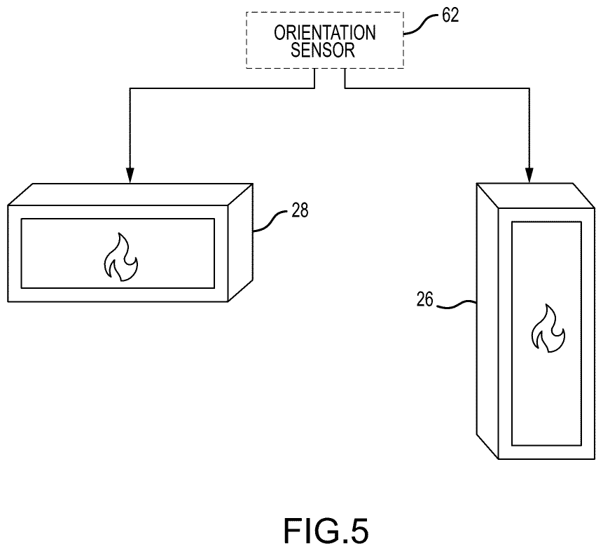

In other embodiments, and as further discussed with respect to FIGS. 4-5, the electric fireplace 14 may instead be mounted in a horizontal orientation 28. The horizontal orientation 28 may be angularly offset from the vertical orientation 26 by approximately 90 degrees, or even at other angles including approximately 20 degrees, approximately 45 degrees, or approximately 70 degrees from the vertical orientation 26. In some embodiments, the visual representation of the fire 30 is configured to selectively display vertically or horizontally, corresponding to the orientation of the screen 32.

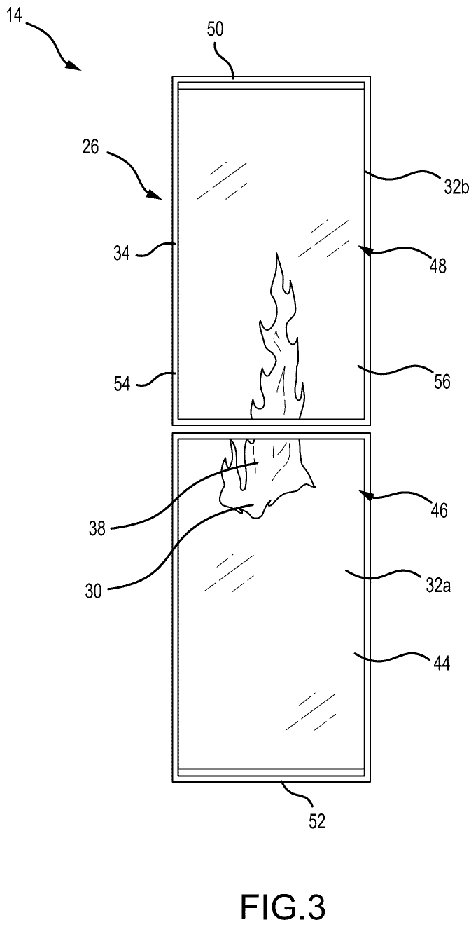

FIG. 3 shows another embodiment of an electric fireplace 14, which includes substantially similar elements as FIG. 2.

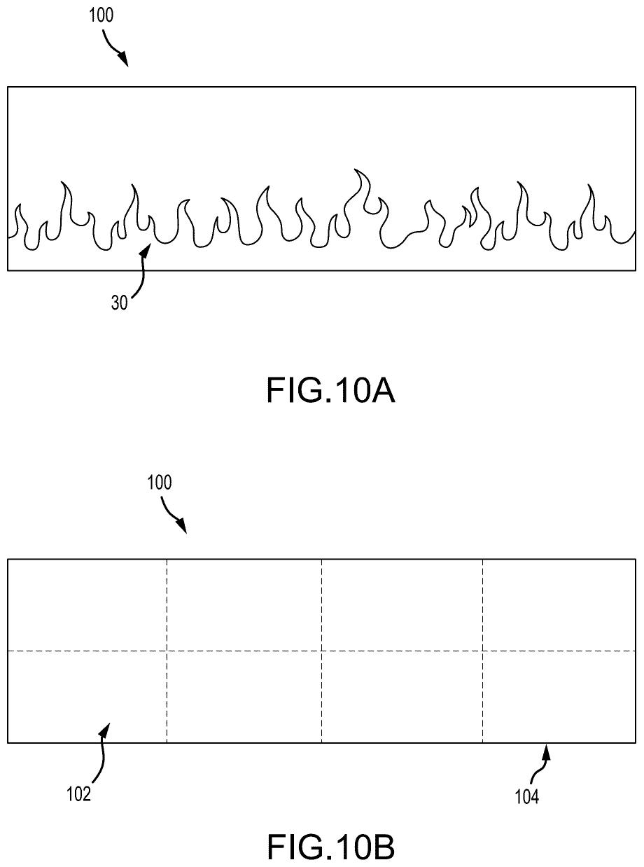

As shown in FIG. 3, the electric fireplace system may include more than one screen 32, and optionally the first and second screens 32a, 32b. Both of the first and second screens 32a, 32b may be digital displays. The visual representation of the fire 30 may extend over at least a portion of one of the first and second screens 32a, 32b, or may extend over at least a portion of both the first and second screens 32a, 32b, as shown. Separate images may be displayed on each of the first and second screens 32a, 32b, or a single image may be displayed across the two or more screens 32. In some embodiments, and as discussed further with respect to FIGS. 10A-14, the electric fireplace 14 may be defined by a plurality of panels 102 (FIG. 10B) forming a modular array 104 (FIG. 10B) that can optionally be customized to a user's preference. The electric fireplace 14 of FIG. 3 may be mounted to the wall in a vertical orientation 26 or a horizontal orientation 28.

FIG. 4 shows another embodiment of the electric fireplace 14, which includes substantially similar elements as FIGS. 2-3. FIG. 4 shows a visual representation of the fire 30 including a flame 38, a fuel source 40 (e.g., wood logs), and a grate 60 to simulate a burning fireplace.

As shown in FIG. 4, the electric fireplace 14 is mounted in the horizontal orientation 28, which is angularly offset from the vertical orientation 26 of FIG. 2 by approximately 90 degrees. The ability to selectively mount the electric fireplace 14 in either the vertical orientation 26 (e.g., FIG. 2) or the horizontal orientation 28 (e.g., FIG. 4) offers versatility to the user.

In some embodiments, the electric fireplace 14 includes an orientation sensor 62 (FIG. 5) operatively coupled to the screen 32 of the electric fireplace 14 and configured to sense a direction of the screen orientation, such as whether the screen 32 is vertical or horizontal, which is further discussed with respect to FIG. 5.

FIG. 5 shows a diagram of the orientation sensor 62 of the electric fireplace 14. In some embodiments, the orientation sensor 62 is operatively coupled to the screen 32 of the electric fireplace 14. The orientation sensor 62 is configured to sense a direction or orientation of the screen 32 and is configured to selectively display or orient the visual representation of the fire 30 to match the orientation of the screen 32. For example, when the electric fireplace 14 is mounted in the vertical orientation 26, the orientation sensor 62 detects the vertical orientation 26 of the screen 32 and orients the visual representation of the fire 30 to be in the corresponding vertical orientation 26 (e.g., as shown in FIG. 2). When the electric fireplace 14 is mounted in the horizontal orientation 28, the orientation sensor 62 detects the horizontal orientation 28 of the screen 32 and orients the visual representation of the fire 30 to be in the corresponding horizontal orientation 28 (e.g., as shown in FIG. 4). As such, the electric fireplace 14 can be installed in either the vertical or horizontal orientations 26, 28, or may be re-mounted to change orientation, and still correctly display the visual representation of the fire 30.

In other embodiments, the housing 34 and/or enclosure may include a switch operatively coupled to the screen 32, and accessible by the installer, allowing the installer to manually select either a vertical or horizontal orientation 26, 28 for the screen 32 upon installation.

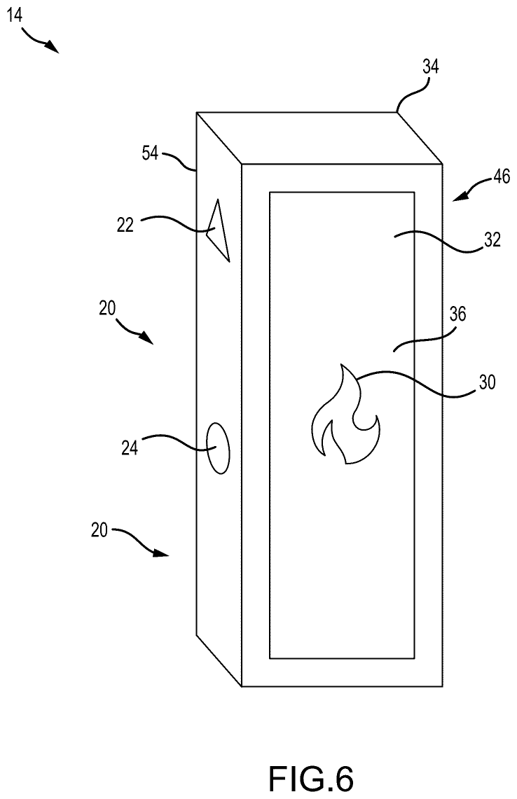

FIG. 6 shows an embodiment of the electric fireplace 14 with one or more accessories 20 operatively coupled to the housing 34. The one or more accessories 20 may be positioned anywhere along the frame perimeter 46 on the front face 36 of the frame 44. For illustration, the one or more accessories 20 are shown coupled on the first side 54 of the housing 34. FIG. 7 shows a diagram of the one or more accessories 20 in communication with a controller 64. The controller 64 may include, but is not limited to, a remote control or a smart home system or other controllers such as a single board or processor in the product itself.

The controller 64 may be or include one or more processing units, such as a central processing unit (“CPU”), and one or more memory units that may be or include a non-transitory computer-readable medium that store instructions which, when executed by the processing unit(s), causes the processing unit(s) to perform or run one or more processes, algorithms, or operations as stored in the medium. Examples of such memory units may include, but are not limited to, random access memories, read only memories, flash memories, disk drives, removable storages, and any other suitable types of storage as known in the art. The controller 64 is capable of receiving, analyzing, and transmitting electrical signals. The controller 64 is operatively coupled with at least the display (such as screen 32) and/or the heating system 22, and is capable of controlling, in response to a user input such as electrical signals transmitted from a user device 66, the operation of the screen 32 and the heating system 22, as well as other accessories 20 with which the controller 64 may be operatively coupled.

In some examples, user inputs may be provided remotely via one or more user devices 66 such as a smartphone or remote controller. User inputs may be wirelessly transmitted using a remote controller (e.g., wireless and/or wired control source), software application (“app”) on the user device 66, and/or other controller(s) as incorporated in the electric fireplace system 10.

The one or more accessories 20 can include the heating system 22 to simulate heating of a burning fireplace. The heating system 22 may include one or more heaters positioned along the frame perimeter 46. The heaters can include, but are not limited to, electric powered heaters or gas powered heaters. The one or more heaters may be operatively coupled to a fan and a vent of the heating system 22 to allow the heat to flow outwardly from the electric fireplace 14 to provide heat to the environment (e.g., a room). In some embodiments, the heating system 22 can be turned on and off using the controller 64. For example, the user can use a remote or a smart home system (e.g., as facilitated by an app) to turn the heating system 22 on and off. For example, the controller 64 can be used to selectively turn the heat up to increase the temperature of the room or selectively turn the heat down to decrease the temperature of the room. In other embodiments, the housing 34 may include a user input (e.g., a button, dial, or a switch) that allows the user to manually turn the heating system 22 on and off, or control an amount of heat emitted.

In some embodiments, the heating system 22 may be operatively coupled to the screen 32. For example, the amount of heat provided to the environment may be generally represented by the visual representation of the fire 30. For example, when the heat is turned up to increase the temperature of the room, the flames 38 can increase in size to indicate a relatively hotter system. When the heat is turned down to decrease the temperature of the room, the flames 38 can decrease in size to indicate a cooler system.

The one or more accessories 20 may also include the speaker system 24 to provide audio simulating a burning fireplace. The speaker system 24 may include one or more speakers positioned along the perimeter of the frame perimeter 46. In some embodiments, the speaker system 24 can be turned on and off using the controller 64. For example, the user can use the remote or the smart home system (e.g., as facilitated by an app) to turn the speaker system 24 on and off, or to adjust the volume of the speaker system 24. In other embodiments, the housing 34 may include a user input (e.g., a button, dial, or a switch) that can manually turn the speaker system 24 on and off or adjust the volume.

Similar to the heating system 22, a volume of sound provided to the environment can be controlled by the user. For example, the controller 64 can be used to selectively turn the speaker sound up to increase the volume or selectively turn the speaker sound down to decrease the volume. In other embodiments, the housing 34 may include a user input (e.g., a button, dial, or a switch) that can manually change the amount of sound provided by the speaker system 24.

In some embodiments, the speaker system 24 may be operatively coupled to the screen 32. For example, the volume of sound provided to the environment may be generally represented by the visual representation of the fire 30. In some embodiments, the amount of heat and the volume of sound provided to the environment are operatively coupled and rise and fall together. For example, when the heat is turned up, the volume of sound may increase, and the flames 38 may increase in size. When the heat is turned down, the speaker volume may also decrease, and the flames 38 may decrease in size.

In some embodiments, the screen 32 is operatively coupled to the controller 64. A user may control, via the user device 66, one or more of a foreground image 68 and/or a background image 70 (FIG. 14) of the electric fireplace 14. In some examples, the foreground image 68 is the visual representation of the fire 30. The foreground image 68 may be changed to include flames 38 with various intensities (e.g., small, medium, or large) and fireplace types (e.g., driftwood, firepit, or gas flame). The background image 70 may include various textures or sceneries (e.g., bricks, stones, or outdoor sceneries). In some examples, the foreground and background images 68, 70 may be preconfigured such that the user may select one or more of the preconfigured foreground and/or background images 68, 70 separately or together as a set. When selected as a set, the combination of the preconfigured foreground and background images 68, 70 may be displayed, replacing the current image or video that is displayed on the screen 32. When one of the foreground and background images 68, 70 is selected, the selected foreground or background image 68, 70 may replace the corresponding foreground or background image 68, 70 of the current image or video that is displayed on the screen 32. As such, the screen 32 and images of the electric fireplace 14 may be fully customizable by the user.

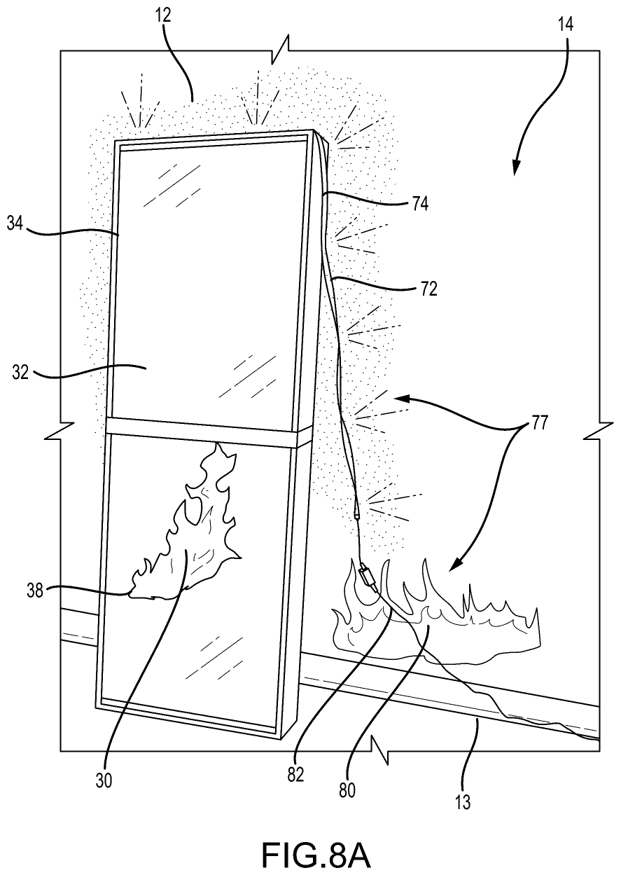

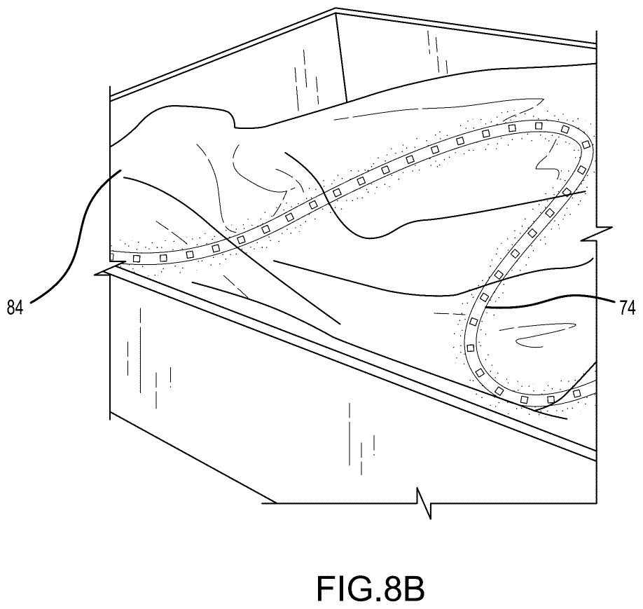

FIG. 8A shows the electric fireplace 14 with one or more rear facing lighting elements 72. The one or more rear facing lighting elements 72 may be coupled to the housing 34 at or near the back face of the frame 38 (e.g., facing a wall), generally opposite to the screen 32. The one or more rear facing lighting elements 72 can include, but are not limited to, a plurality of LEDs 74. The plurality of LEDs 74 may be generally arranged in a generally linear strip or may be provided in an array along portions of the housing 34.

The one or more rear facing lighting elements 72 may be configured to the display light 76 on portions of the wall 12 and/or a floor 13 behind the electric fireplace 14 to enhance lighting of the electric fireplace 14. The one or more rear facing lighting elements 72 may cast both light and shadows onto the wall 12 and/or floor 13 to extend and enhance the illusion of flames 38. In some embodiments, the one or more rear facing lighting elements 72 display dynamic lighting configured to simulate a flame effect. In some examples, the dynamic lighting simulates a flame effect by the plurality of LEDs 74 randomly turning on and off to simulate flickering or scattering of light or to mimic the movement of flames. The dynamic lighting may be displayed about an environment of the electric fireplace system 10, such as along the wall 12 and/or the floor 13. The dynamic lighting increases realism of the electric fireplace 14, such that the electric fireplace 14 creates a cozy or warming environment without burning flames. The one or more rear facing lighting elements 72 may be programmed to simulate flickering or scattering, including but not limited to be programmed using a chaos circuit 78 (FIG. 7), such as the chaos circuit 78 disclosed in U.S. patent application Ser. No. 16/021,631 granted as U.S. Pat. No. 10,508,785, the entire disclosure of which is incorporated by reference. In this manner, the display light 76 may appear animated to simulate bouncing and flickering light produced by real, burning flames. In other embodiments, the one or more rear facing lighting elements 72 includes a projection 80 of an ember bed 82 including images or video of burning embers, sparks and/or flames 38. The projection 80 may be provided on the wall 12 and/or the floor 13.

As shown in FIG. 8B, the one or more rear facing lighting elements 72 (FIG. 8A) may include a cover 84 extending over at least a portion of the rear facing lighting elements 72, including over at least a portion of the plurality of LEDs 74. The cover 84 may comprise lenses or optical elements that shape, diffuse, or scatter light. The cover 84 may comprise materials that are translucent, semi-transparent, opaque, or semi-opaque. The cover 84 may also be treated to be generally opaque, translucent, reflective, or semi-reflective. The cover 84 may include, but is not limited to smoke treatment, film treatment, polarizing treatment, fabric, glass, granite, and alabaster. The cover 84 may blur or semi-obstruct the individual lights and the light emitted to further simulate a flame appearance.

In some embodiments, the one or more rear facing lighting elements 72 may be operatively coupled to the controller 64 of FIG. 7. As such, the user may selectively turn on or off the one or more rear facing lighting elements 72 using the controller 64. In some embodiments, the one or more rear facing lighting elements 72 are operatively coupled to the screen 32 via the controller 64. For example, when the visual representation of the fire 30 on the screen 32 increases in size, the one or more rear facing lighting elements 72 may brighten to simulate larger flames 38. The opposite is contemplated where the one or more rear facing lighting elements 72 are brightened, the flame 38 on the screen 32 increases in size. When the visual representation of the flame 38 on the screen 32 decreases in size, the one or more rear facing lighting elements 72 may dim to simulate a smaller flame 38. The opposite is contemplated where the one or more rear facing lighting elements 72 are dimmed, the flame 38 on the screen 32 decreases in size. The one or more rear facing lighting elements 72 may also be configured to respond to changes in the one or more accessories 20 via the controller 64. For example, when the amount of heat of the heating system 22 is increased, the one or more rear facing lighting elements 72 may brighten and when the heat of the heating system 22 is decreased, the one or more rear facing lighting elements 72 may dim. Similarly, when the amount of sound of the speaker system 24 is increased, the one or more rear facing lighting elements 72 may brighten and when the sound of the speaker system 24 is decreased, the one or more rear facing lighting elements 72 may dim.

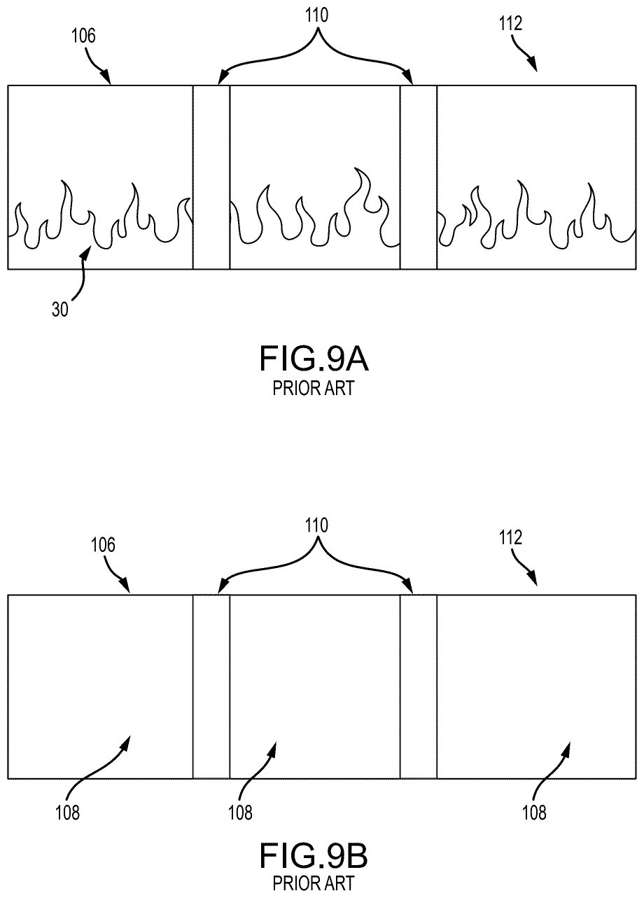

Turning to FIGS. 9A-10B, in some embodiments, an electric fireplace 100 may include one or more displays or panels 102 arranged in an array 104. The electric fireplace 100 may be similar to the electric fireplace 14 described above. FIGS. 9A-9B illustrate a prior art example of an electric fireplace 106 made of three displays 108, wherein the three displays 108 are separated by bezels 110. The bezels 110 are dead space between the displays 108 defined by framing 112 of the displays 108. Visual representations of the fire 30 can be displayed on the three displays 108. In some embodiments, different visual representations of the fire 30 can be displayed on each of the three displays 108. In other embodiments, a single visual representation of the fire 30 can be extended along each of the three displays 108. However, in such embodiments, the visual representation of the fire 30 is not shown in the bezels 110 such that the visual representation of the fire 30 is not-continuous across the displays 108 and is interrupted by dead space.

In contrast, FIGS. 10A-10B show the electric fireplace 100 comprised of the plurality of panels 102 defining the array 104. The plurality of panels 102 may include LED panels. The plurality of panels 102 may be generally rectangular in shape. As shown in FIG. 10B, the plurality of panels 102 are arranged adjacent to each other without bezels or dead space between the adjacent panels 102. As such, as shown in FIG. 10A, the visual representation of the fire 30 may extend continuously and uninterrupted across the array 104 such that the visual representation of the fire 30 is not interrupted. In some examples, having the visual representation of the fire 30 extending continuously across the array 104 can increase the realism of the electric fireplace 100 as compared to systems with bezels 110 (FIGS. 9A-9B). In other embodiments, different visual representations of the fire 30 can be displayed on each of the panels 102, or a single visual representations of the fire 30 may extend over only a portion of the plurality of panels 102 (e.g., across panels in a middle of the array 104 and not at an end of the array 104, or vice-versa). Each panel 102 of the array 104 may be individually controllable by the controller 64 in the manner described with respect to FIG. 7.

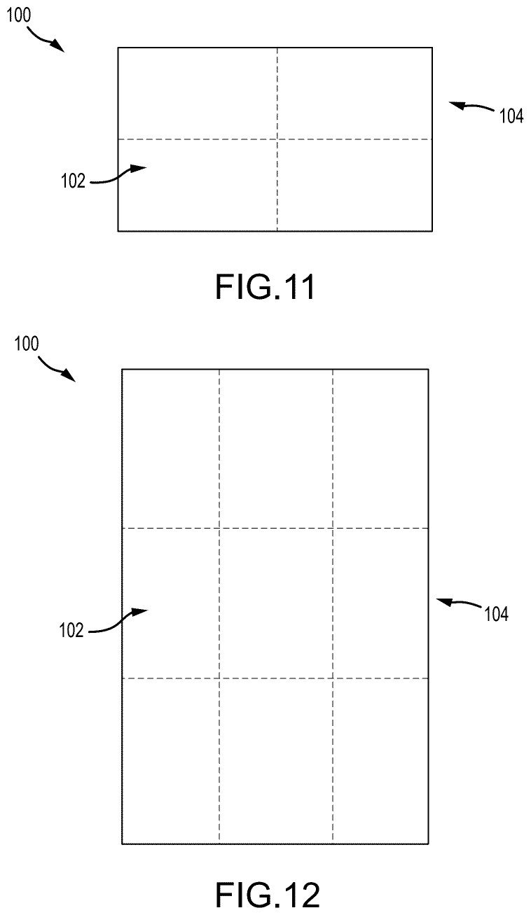

As shown in FIG. 10B, the array 104 is defined by eight panels 102. However, any number of panels 102 may be used to define the array 104. For example, FIG. 11 shows an embodiment where the array 104 is defined by four panels 102. In the embodiment of FIG. 11, the visual representation of the fire 30 may extend continuously and uninterrupted along each of the four panels 102, or may extend across only a portion of the panels 102. Similarly, FIG. 12 shows an embodiment of the electric fireplace 100 defined by nine panels 102. In the embodiment of FIG. 12, the visual representation of the fire 30 may extend continuously along each of the nine panels 102, or may extend across only a portion of the panels 102. In other embodiments, different visual representations of the fire 30 may be displayed on each of the nine panels 102. The electric fireplaces 100 may also be arranged either vertically or horizontally. FIG. 12 shows the generally vertical orientation 26 of the electric fireplace 100 and FIGS. 10A-11 shows the generally horizontal orientation 28 of the electric fireplace 100.

The array 104 of the panels 102 of the electric fireplaces 100 shown and described with respect to FIGS. 10A-12 may be modular, or in other words can be custom arranged in any shape based on user preference. The modularity of the electric fireplaces 100 also allow for the panels 102 to be arranged in dimensions uncommon for screens (such as sizes other than those available for a standard LCD screen) or can be arranged to fit different aspect ratios. For example, the electric fireplaces 100 can include any number of the panels 102, such as one panel 102, four panels 102, ten panels 102, and so on. The number of panels 102 can be customized to a preference of the user and can be arranged to fit different spaces of a home or other building. The panels 102 may be arranged in a variety of shapes, including but not limited to, squares, rectangles, L-shapes, U-shapes, or others. The panels 102 can also be arranged to a customized aspect ratio such that the visual representation of the fire 30 are generally vertical or generally horizontal. The modularity can allow for user customization allowing the electric fireplace 100 to fit within a wide variety of spaces within a home or other building. For example, the electric fireplace 100 can be modularly designed to span multiple rooms of a home, or alternatively, can be designed to fit within a smaller space such as an apartment.

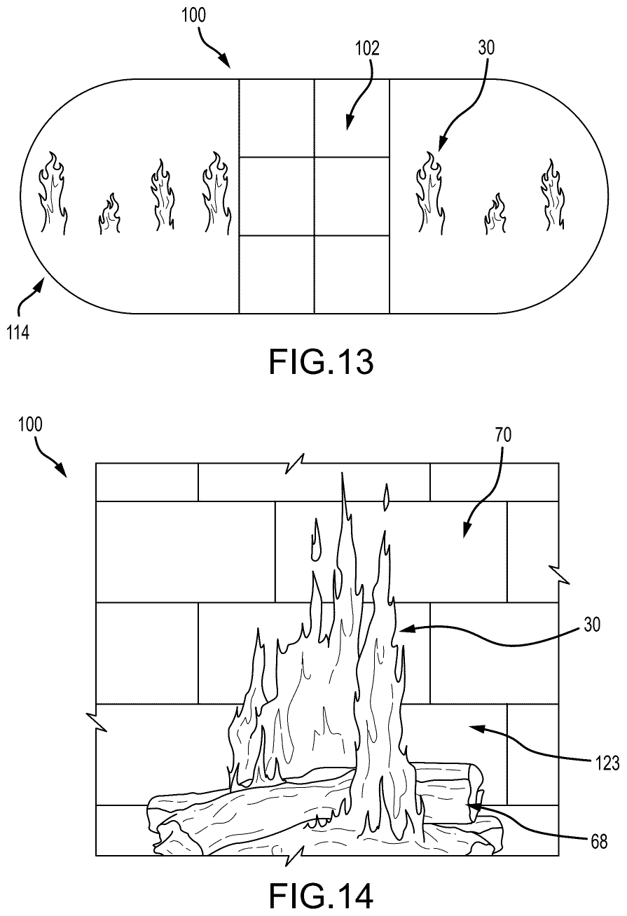

FIG. 13 shows another embodiment of the electric fireplace 100 in which at least a portion of the panels 102 include non-linear edges 114. Similar to the embodiment of FIGS. 10A-12, the embodiment of FIG. 13 can be modular and customized in shape. For example, the non-linear edges 114 may be rounded or curved. The non-linear edges 114 can increase the modularity of the electric fireplaces 100 and allow the user to have further customized shapes. In some examples, the electric fireplace 100 can be configured to have curved edges (e.g., a circular or oval shape), an S-shaped curve, or other customized shapes.

The electric fireplaces 100 of FIGS. 10A-13 may include backlighting defined by the rear facing lighting elements 72, such as those described with respect to FIG. 8A. The rear facing lighting elements 72 may provide additional realism to the electric fireplaces 100 by providing the projections 77 along the wall 12 and/or floor 13, simulating flames. In some embodiments, the rear facing lighting elements 72 are controlled by the chaos circuit 78 such that the projections 77 move or flicker, mimicking the movement of real flames. Each of the electric fireplaces 100 of FIGS. 10A-13 may include the accessories 20 as described with respect to FIGS. 6-7, including but not limited to the speaker systems 24 or heating system 22.

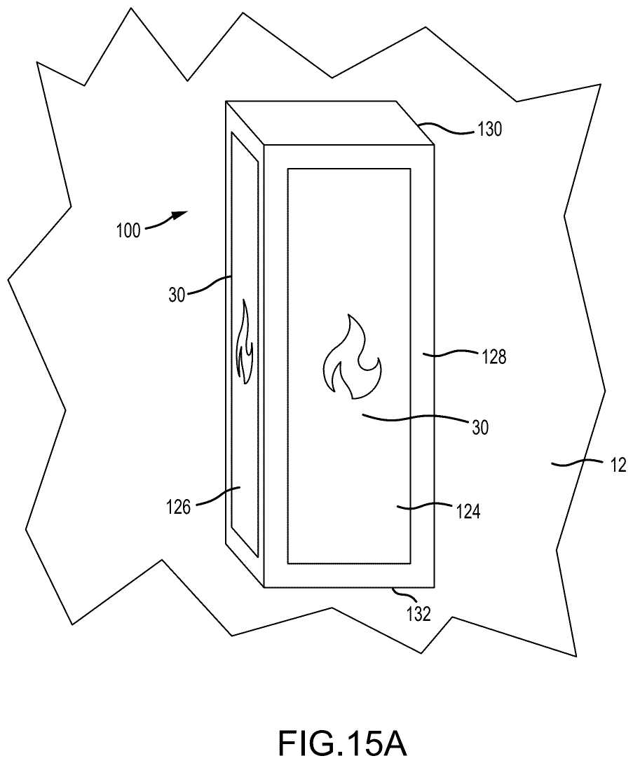

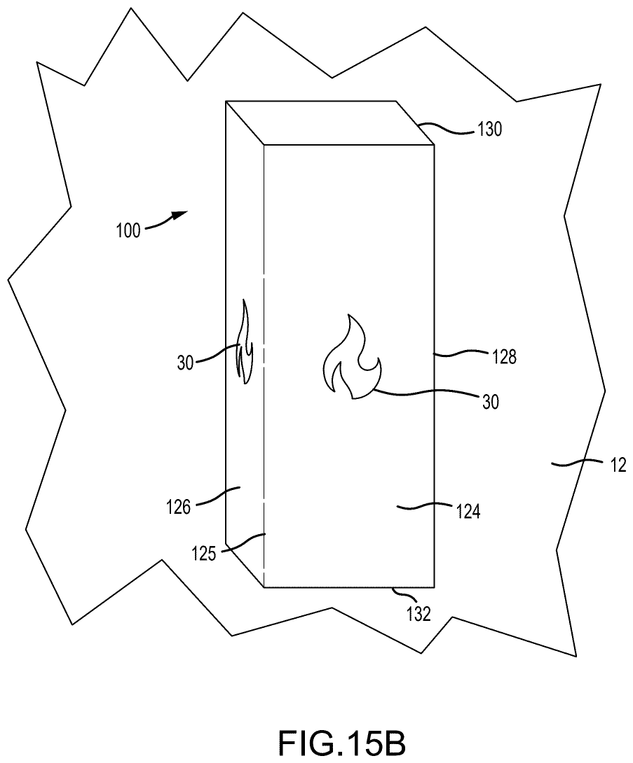

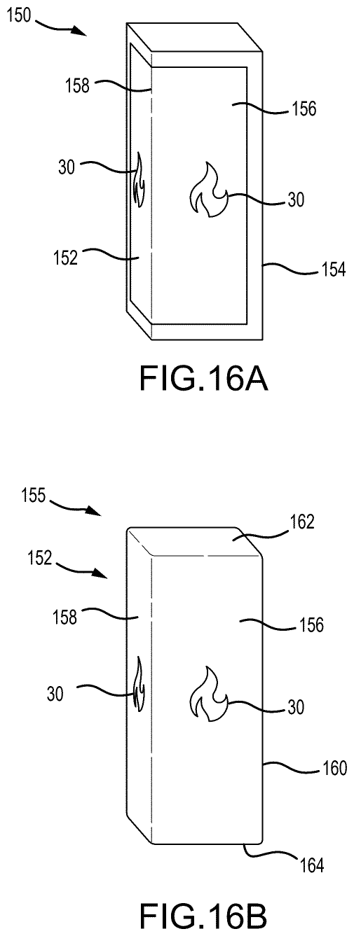

The panels 102 of each of FIGS. 10A-13 may be LED panels (FIG. 16). The LED panels may be defined by LEDs 116 (including micro-LEDs) in which the LEDs 116 extend across each panel 102 and extend to the edges 120 (FIG. 16) of the panel 102 such that the LEDs 116 can provide visual representations of the fire 30 across an entirety of the panel 102. In some embodiments, the visual representation of the fire 30 can fill the entirety of the array 104 to make the electric fireplace 100 look visually larger without increasing a footprint of the electric fireplace 100 and without having the bezels 110, or other dead space between or around adjacent panels 102 of the array 104. In other embodiments, the LEDs 116 may extend about the edges 120 of the panel 102 such that the visual representation of the fire 30 wraps around the panel 102 and increases a viewing angle for a user. For example, the user may be able to view the visual representation of the fire 30 from the front of the array 104, standing at an angle to the array 104, or from the side of the array 104, as further discussed with respect to FIGS. 15A-15B.

The electric fireplaces 100 of any one of FIGS. 10A-13 may include a cover 122 overlaying one or more panels 102. The cover 122 can include, but is not limited to, a transparent cover, a semi-transparent cover, a semi-translucent cover, or a translucent cover. The cover can include, but is not limited to, a glass, a frosted glass, acrylic, frosted or patterned acrylic, or another light diffusing material. The cover 122 may be reflective or semi-reflective and may be a polarizing coating to reduce or prevent glare from other light sources. The cover 122 may obscure features of the panel 102 (such as the individual LEDs 116) to make the visual representation of the fire 30 appear more realistic. In other embodiments, the electric fireplaces 100 can be uncovered. In some embodiments, the panels 102, with or without a cover 122, may be less reflective as compared to a screen, which can avoid non-fire visuals (such as glare) from obstructing a view of the electric fireplace 100, in turn allowing for a more-clear, unobstructed view by the users.

FIG. 14 shows the electric fireplace 100 in which more than one image 123 is projected onto the panels 102. The image 123 includes, but is not limited to, the visual representation of the fire 30. For example, the visual representation of the fire 30 can be paired with the foreground image 68, such as logs or other simulated fuel sources. The visual representation of the fire 30 can additionally, or alternatively, be paired with the background image 70, such as bricks or other backgrounds simulating a fireplace. In other embodiments, the background could be another image, such as a beach, forest, or other nature background. The foreground and/or background images 68, 70 can be customized by the user and can be controllable via the controller in a similar manner as discussed with respect to FIG. 7. The inclusion of foreground and background images 68, 70 can be utilized with any of the electric fireplaces 100 shown and described with respect to FIGS. 10A-13.

In some embodiments, as shown in FIG. 15A, the electric fireplace 100 may project outwardly from the wall 12 such that the electric fireplace 100 includes a front 124, at least two sides 126, 128, a top 130, and a bottom 132. In some embodiments, multiple surfaces, such as the front 124 and the at least one of the two sides 126, 128 of the electric fireplace 100 can include one or more panels 102 such that multiple surfaces of the electric fireplace 100 show the visual representation of the fire 30. In this manner, the viewing angle of the electric fireplace 100 can be increased as the user may be able to view the visual representation of the fire 30 by viewing in front of the array 104, viewing at an angle to the array 104, or viewing from the side of the array 104, as opposed to from only one face of the electric fireplace 100. The electric fireplace 100 of FIG. 15A may include the accessories 20 as described with respect to FIGS. 6-7.

FIG. 15B illustrates the electric fireplace 100, similar to FIG. 15A, without bezels or dead space between the front 124 and at least two sides 126, 128. As such, the visual representation of the fire 30 extends substantially continuously and un-interrupted between at least the front 124 and the side 126, including along an edge 125 therebetween. In some embodiments, each of the front 124, the two sides 126, 128 include panels 102 allowing the visual representation of the fire 30 to extend substantially continuously and un-interrupted between the front 124 and the sides 126, 128. Optionally, the top 130 and bottom 132 also include panels 102 to display the visual representation of the fire 30.

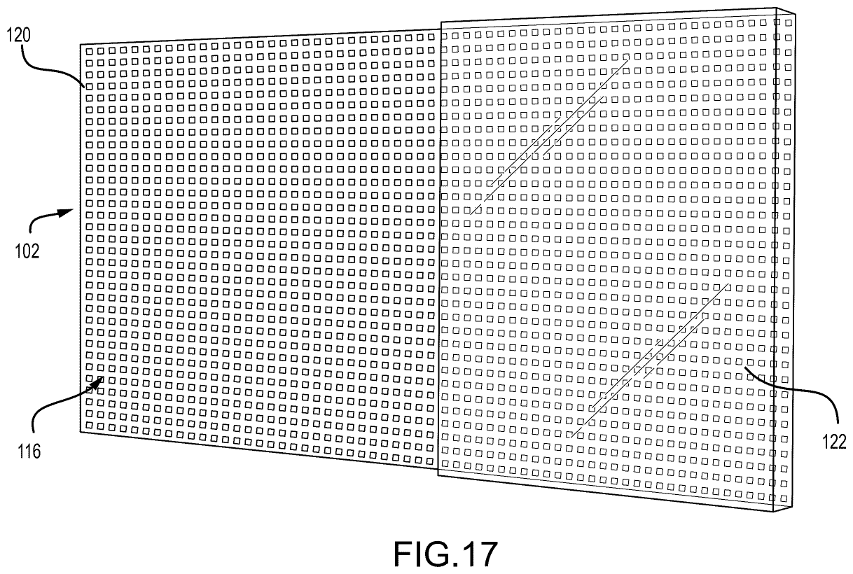

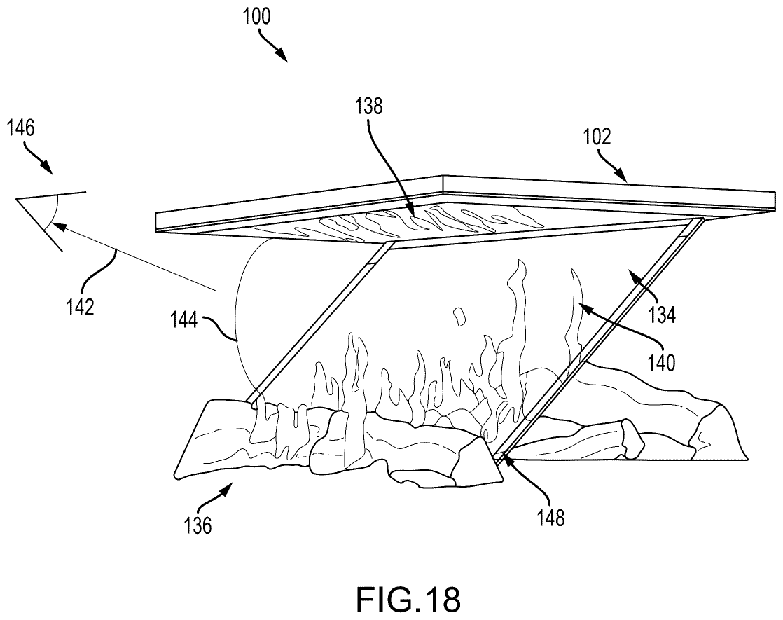

FIG. 16A illustrates an electric light system 150 in accordance with an embodiment. The electric light system 150 includes a light 152 defined by one or more panels 102 (FIG. 17). The light 152 is positioned within a housing 154. FIG. 16B shows the light 152 isolated from housing 154. The light 152 includes a plurality of faces 155 including a front face 156, at least two side faces 158, 160, a rear face (not shown) opposite to the front face 156, a top face 162 (FIG. 16B), and a bottom face 164 (FIG. 16B) opposite the top face 162. At least a portion of the plurality of faces 155 may configured to display the visual representation of the fire 30 via the one or more panels 102. The plurality of faces 155 may have minimal or no dead space therebetween such that the visual representation of the fire 30 extends substantially continuously and un-interrupted around the light 152. The housing 154 may be transparent, semi-transparent, translucent, or semi-translucent to allow light to extend through the housing 154 and outward toward a surrounding environment. In some embodiments, one or more of the front face 156, at least two side faces 158, 160, and the rear face include panels 102 allowing the visual representation of the fire 30 to extend substantially continuously and un-interrupted around the light 152 and along edges between the plurality of faces 155. The light 152 may be operatively coupled to the chaos circuit 78 (FIG. 7) such that the visual representation of the fire 30 flickers or otherwise changes to mimic movement of burning flames.

The electric light system 150 of FIGS. 16A-16B may be configured as a portable electric light system, such as a lantern, that a user may carry. In such embodiments, the housing 154 includes a handle (not shown). In other embodiments, the electric light system 150 may be placed on a surface, such as a table or floor, and can optionally act as a centerpiece.

FIG. 17 shows an example of the panel 102 comprised of a plurality of LEDs 116. The LEDs 116 of the panel 102 can provide deeper contrasts (e.g., deeper blacks and/or more vibrant colors) and increased brightness/Nit valve (e.g., where Nit is defined as candela per meter squared (m2) measured at 1 meter from the light source) as compared to that of an LCD screen. As such, a viewing angle of the LEDs may be greater than that of the LCD screen due to the contrast and brightness. Additionally, the panel 102 may provide a longer lifespan as compared to an LCD screen. In some examples, a lifespan of the panel 102 may be on the order of about 100,000 hours and a lifespan of the LCD screen may be on the order of about 60,000 hours. The increase in lifespan can improve the user experience by reducing the need to service and/or replace parts of the electric fireplace 100. Additionally, an individual panel 102 of the plurality of panels 102 of the electric fireplace 100 may be repaired and/or replaced instead of requiring replacement of the entire screen or the entire electric fireplace 100.

This panel 102 may be used in any of the embodiments in FIGS. 1-16B and FIG. 19. In some embodiments, the cover 122 is one of a transparent, semi-transparent, translucent, or semi-translucent material. In other embodiments, the LED panel 102 does not include the cover 122, and instead, the LED panel 102 itself includes a transparent, semi-transparent, translucent, or semi-translucent material. In some embodiments, the LED panel 102 displays images and/or videos of burning flames. In other embodiments, the LED panel 102 may be operatively coupled to the chaos circuit 78 (FIG. 7) allowing lights to flicker or blink such that the simulated flames appear to move, simulating a real burning flame.

Turning to FIG. 18, in some embodiments, the electric fireplace 100 can include at least one panel 102, a cover material 134, and optionally, a physical media 136. As shown, the at least one panel 102 may be mounted or otherwise suspended above the cover material 134. The panel 102 may display a representation of the fire 138 and reflect the representation of the fire 138 onto the cover material 134. The cover material 134 may then display a reflected representation of the fire 140 outwardly to the user, as shown by the arrow 142. The representation of the fire 140 may be a realistic image of the fire 138, and the reflected representation of the fire 140 may soften the representation of the fire 138 for the user, to simulate a live fire. The cover material 134 may also obscure the individual LEDs 116 of the panel 102 such that the LEDs 116 are hidden from view. A viewing angle 144 of the electric fireplace 100 may be such that the panel 102 is hidden from view and the user 146 sees just the reflected representation of the fire 140 and optionally the physical media 136. The electric fireplace 100 of FIG. 18 may include the accessories 20 as described with respect to FIGS. 6-7. The physical media 136 includes, but is not limited to, decorative logs or coals. The physical media 136 may be positioned in front of the cover material 134, may surround a side of the cover material 134, may be positioned behind the cover material 134, or a combination thereof. The physical media 136 may hide a coupling point between a housing 148 of the electric fireplace 100 and the cover material 134.

The cover material 134 can include, but is not limited to, glass, frosted glass, acrylic, frosted or patterned acrylic, or another light diffusing material. In some embodiments, where the cover material 134 is at least semi-transparent, the physical media 136 may be positioned both in front of and behind the cover material 134. The cover material 134 is reflective or semi-reflective to produce the reflected visual representation of the fire 140 for the user. The cover material 134 may also include a polarizing coating to prevent or reduce glare from other lighting in the environment, such that the reflected visual representation of the fire 140 is substantially uninterrupted.

The electric fireplaces of this application have been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention, provided they come within the scope of the appended claims and their equivalents.

Various modifications and additions can be made to the exemplary embodiments discussed without departing from the scope of the present invention. For example, while the embodiments described above refer to particular features, the scope of the invention also includes embodiments having different combinations of features and embodiments that do not include all of the above-described features.

1. An electric fireplace comprising:
a housing including a screen configured to display a visual representation of a flame, the screen configured to be mounted in a screen orientation;
an orientation sensor operatively coupled to the screen and configured to sense a direction of the screen orientation and selectively display the visual representation in a visual direction corresponding to the direction of the screen orientation; and
at least one rear facing lighting element coupled to the housing opposite the screen, the at least one rear facing lighting element configured to display dynamic lighting.

2. The electric fireplace of claim 1, further comprising a controller operatively coupled to the at least one rear facing lighting element.

3. The electric fireplace of claim 2, wherein the controller includes one of a mobile app, a remote, and a smart home system.

4. The electric fireplace of claim 2, further including a heating system including at least one heater coupled to the housing and operatively coupled to the controller.

5. The electric fireplace of claim 2, further including a speaker system including at least one speaker coupled to the housing and operatively coupled to the controller.

6. The electric fireplace of claim 1, wherein the screen includes a digital display including at least one of a television, a computer monitor, a liquid crystal display, an organic light-emitting diode, an array or strip of light emitting diodes (LED), and a panel of LEDs.

7. The electric fireplace of claim 1, wherein the at least one rear facing lighting element includes a plurality of LEDs.

8. The electric fireplace of claim 1, wherein the electric fireplace is configured to mount onto a wall, and the at least one rear facing lighting element displays dynamic lighting onto the wall.

9. The electric fireplace of claim 1, wherein the at least one rear facing lighting element includes a cover, and the cover includes at least one of a transparent, semi-transparent, opaque, or semi-opaque material.

10. The electric fireplace of claim 1, wherein the screen orientation is generally vertical.

11. The electric fireplace of claim 1, wherein the screen orientation is generally horizontal.

12. An electric fireplace comprising:
a display defined by a plurality of individual LED panels arranged in an array such that an image extends continuously and uninterrupted across at least a portion of the plurality of panels; and
a controller operatively coupled to the display, the controller operable to change one or more properties of the display in response to a user-input.

13. The electric fireplace of claim 12, wherein the image extends to an edge of each panel of the plurality of panels.

14. The electric fireplace of claim 12, wherein the array is modular and can be configured into a customized shape.

15. An electric fireplace comprising:
a display defined by a plurality of LED panels arranged in a modular array, wherein the modular array is customizable by at least one of a shape of the array or an aspect ratio of the array; and
a controller operatively coupled to the display, the controller operable to change one or more properties of the display in response to a user-input.

16. The electric fireplace of claim 15, wherein the shape includes one of a rectangle, a square, an L-shape, or a U-shape.

17. The electric fireplace of claim 15, wherein at least one panel of the plurality of panels includes a non-linear edge.

18. The electric fireplace of claim 17, wherein the shape includes one of a circle, an oval, or a curve.

19. The electric fireplace of claim 15, wherein each panel of the plurality of panels is individually controllable by the controller.

20. The electric fireplace of claim 15, further comprising one or more accessories operatively coupled to the controller, wherein the one or more accessories include a speaker system, a heating system, and a backlight.

21. An electric fireplace configured to mount to a wall, the electric fireplace comprising:
a housing having a front facing side and a rear facing side opposite the front-facing side, the front facing side including a screen configured to display a video of a flame, the housing including a frame defining a perimeter;
a speaker assembly coupled to the perimeter;
a heating assembly coupled to the perimeter;
at least one rear facing lighting element coupled to the rear facing side of the housing, the at least one rear facing lighting element configured to display dynamic lighting onto the wall; and
a controller operatively coupled to the speaker assembly, the heating assembly, and the at least one rear facing lighting element,
wherein an input signal from any of the speaker assembly, the heating assembly, or the at least one rear facing lighting elements changes a feature of the video of the flame.

22. The electric fireplace of claim 21, wherein when the input signal causes an increase in heat production of the heat assembly, and the feature of the video is an increase in a height of the flame.

23. The electric fireplace of claim 21, wherein when the input signal causes a decrease in heat production of the heat assembly, and the feature of the video is a decrease in a height of the flame.

24. The electric fireplace of claim 21, wherein when the input signal causes an increase in volume from the speaker assembly, and the feature of the video is an increase in a height of the flame.

25. The electric fireplace of claim 21, wherein when the input signal causes a decrease in volume from the speaker assembly, and the feature of the video is a decrease in a height of the flame.

26. The electric fireplace of claim 21, wherein when the input signal causes an increase in brightness from the at least one rear facing lighting element, and the feature of the video is an increase in a height of the flame.

27. The electric fireplace of claim 21, wherein when the input signal causes a decrease in brightness from the at least one rear facing lighting element, and the feature of the video is a decrease in a height of the flame.
